(19) United States
(12) Patent Application Publication
(10) Pub. No.: US 2014/0196449 A1
(43) Pub. Date: Jul. 17, 2014

(54) Hydraulic Drive Circuit

(71) Applicant: Gerry Petty, Adairsville, GA (US)

(72) Inventor: Gerry Petty, Adairsville, GA (US)

(21) Appl. No.: 13/739,358

(22) Filed: Jan. 11, 2013

(51) Int. Cl. F15B 15/00

(52) U.S. Cl. CPC F15B 15/00
USPC 60/487

(57) ABSTRACT

A hydraulic drive circuit using a variable displacement bi-directional pump with two (2) two speed motors enabling drive torque variation as required compensating for a changing load distribution on a machine encountering varying weight distributions at the two drives resulting from operating on slopes.

### CROSS REFERENCES TO RELATED APPLICATIONS

U.S. Provisional Application for Patent No. 61/585,316, filed Jan. 11, 2012 which is hereby incorporated by reference. Applicant claim priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present invention relates to a hydraulic drive circuit which solves the problem of drive slippage during steep slope operation of machinery driven by two or more hydraulic motors in a parallel circuit, such as, but not restricted to, road rollers and soil compactors.

2. Brief Description of Prior Art

Prior art construction machines, such as but not restricted to road rollers and soil compactors, referring to FIGS. 1, 2 and 3, include a hydraulic drive circuit, designated as numeral 1, with a variable displacement bi-directional hydraulic pump, 4 that is in hydraulic communication with, and drives a front fixed displacement motor 3 which is mechanically connected to, and drives, a front drive 6, shown as a drum and a rear dual displacement hydraulic drive motor 2, which is mechanically connected to, and drives, an axle, 5 and finally two wheels, 7. The motors are in parallel hydraulic communication with each other and the propelling pump.

The prior art works quite well on level ground, and also when the front drive 6 is reading a machine such as, but not restricted to, a road roller or soil compactor when climbing a slope, as shown in FIG. 2. However, when the front drive 6 is following the rear drive 5, climbing a slope, as indicated in FIG. 3, a road roller or soil compactor's weight distribution will shift from the rear drive 5 to the front drive 6, lessening the weight carried by the rear drive 5. Said another way, when operating on any slope there is a shift of the machines center of gravity towards the bottom of said slope. This effect is proportional and the degree to which it affects the travel function is directly related to the angle of the slope. As the motors 2 and 3 are in parallel communication, and there is less weight on the rear drive 5, with a sufficiently steep slope 13, the rear drive 5 overcomes the available traction, and slips. As the rear drive 5 slips, all hydraulic oil flows through the rear drive motor 2. Hydraulic pressure in the drive circuit 1 is the regulated by friction between the wheels and the ground, which is insufficient pressure to actuate the front drive motor 2, the road roller or soil compactor stalls on slopes 13 greater than 12 degrees.

The rear drive motor 2 is a two speed hydraulic motor, with dual displacements 9 and 11 preset at 25 or 75 cubic centimeters per revolution, respectively, depending on whether slow speed operation with more rear drive 5 torque for power is appropriate or whether a higher speed at less torque is desired.

The prior art front motor 3 is a fixed displacement hydraulic motor with a typical displacement of 25 cubic centimeters per revolution.

As is known in the prior art, a machine as described above will stall on slopes when travelling in reverse in the high speed setting (Rabbit) or slip at the tires if set in the high torque position (Turtle). To travel up a steep slope an operator must turn the machine around and drive in a forward direction. Under certain job conditions such as trench compaction this does not work as the drum must lead the roller down into the trench. A better way is required, in order to guarantee operations on relatively steep slopes in both forward and reverse travel.

As will be seen from the subsequent description, the preferred embodiment of the present invention improves the performance range of a bi-directional hydraulic drive system.

### SUMMARY OF THE INVENTION

Briefly stated, the present invention is an improvement to a hydraulic drive circuit which broadens the effective performance range of the hydraulic drive circuit by using multiple two speed hydraulic motors in conjunction with a variable displacement bi-directional pump so as to compensate for drive member slippage occurring from weight distribution changes from sloped terrain.

### BRIEF DESCRIPTION OF THE DRAWINGS

FIGS. 1, 2, and 3 illustrate prior art hydraulic drive circuits as applied to a road roller.

FIGS. 4 and 5 illustrate a first embodiment of the present invention, a hydraulic drive circuit.

FIG. 6 illustrates a second embodiment of the present invention.

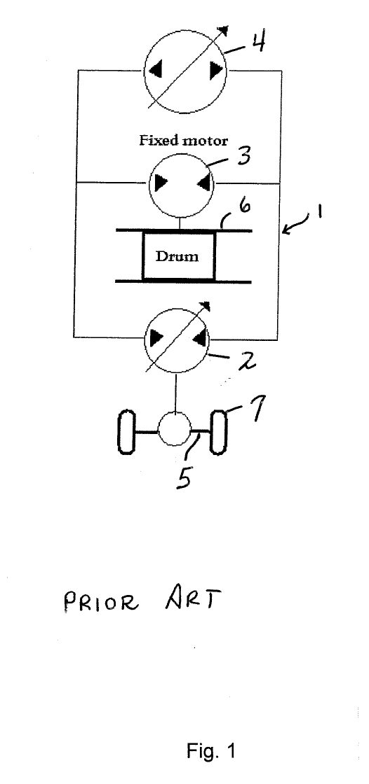

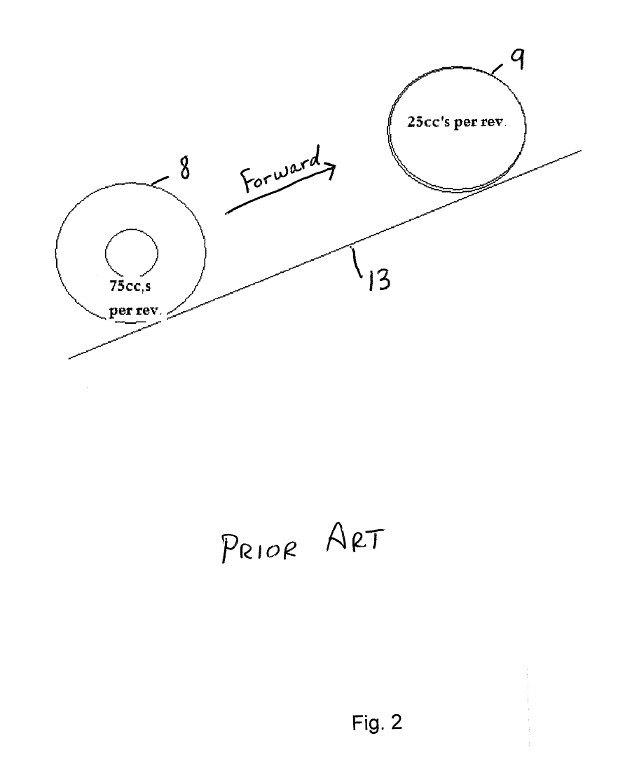

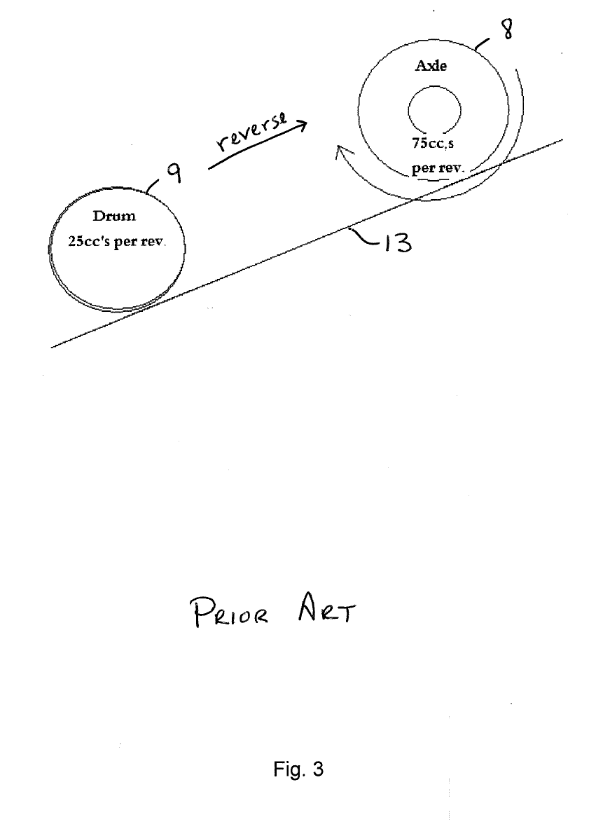

### DESCRIPTION OF THE PREFERRED EMBODIMENT

In accordance with the present invention, a hydraulic drive circuit for solving the problem of overcoming drive slippage in reverse operation of machinery is disclosed. More particularly, the described circuit improves the performance range of a hydraulic drive circuit by using multiple two speed hydraulic motors in conjunction with a variable displacement bi-directional pump. In the broadest context, the disclosed hydraulic drive circuit consists of components configured with respect to each other so as to obtain the desired objective.

The present invention is now exemplified by a particular embodiment which is illustrated in the accompanying drawings.

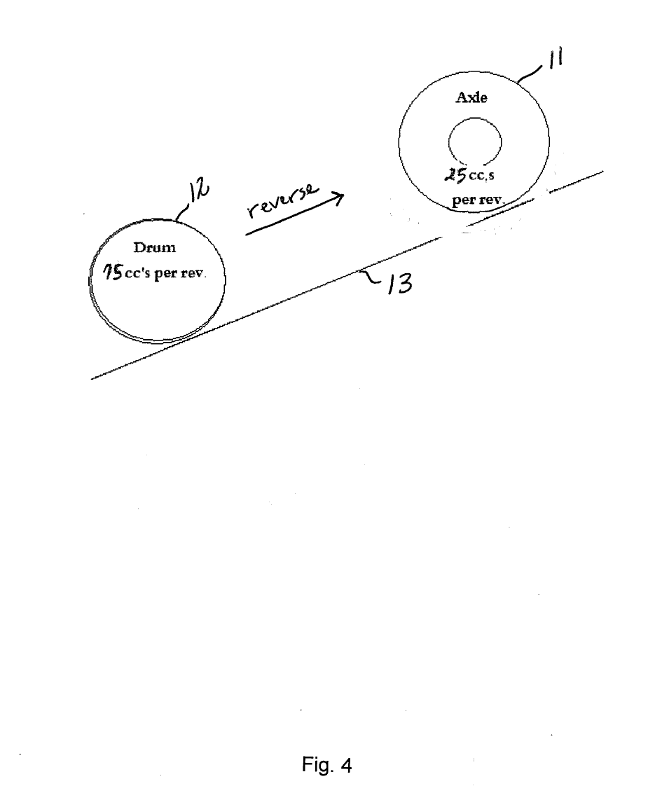

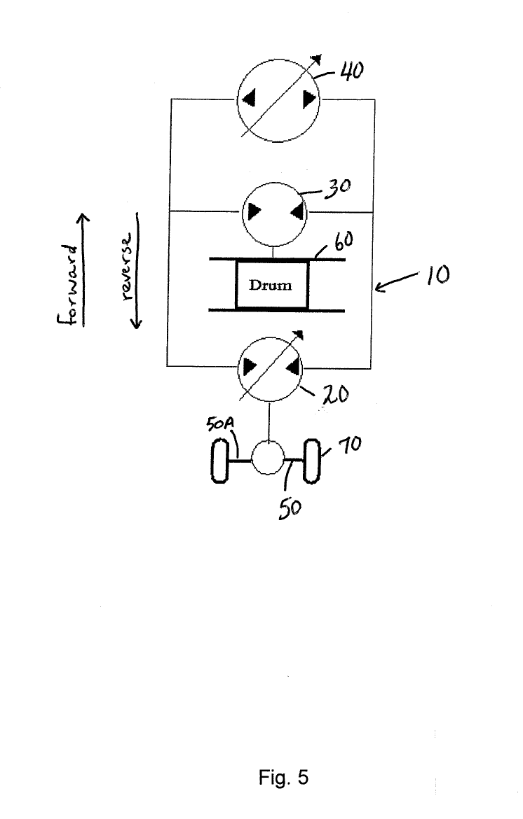

Referring to FIGS. 4 and 5, in the preferred embodiment of the present invention, a hydraulic drive circuit 10 is disclosed. The hydraulic drive circuit 10 comprises a bi-directional hydraulic pump 40 that is in hydraulic communication with a front hydraulic motor 30 and a rear hydraulic motor 20. The front hydraulic motor 30 is in parallel hydraulic communication with the rear hydraulic motor 20.

In the specific illustration, the front motor 30 drives a front drive 60, illustrated as a drum, which can be arranged, for instance, on the front of a road roller. The rear motor 20 drives a rear drive 50 illustrated as an axle 50A with wheels 70. However, as a generic case, the motors 20, 30 could be driving either wheels or drums or both, depending on the function of a given driven vehicle (not shown). In this regard, the motors 20, 30 are preferably constructed identically in order to drive either wheels or drums or both.

In one embodiment, the hydraulic motors, 20, 30, are two (2) speed hydraulic motors that are preset with two (2) displacements, allowing the choice of 25 cubic centimeters per revolution (“cc per rev”) or 75 cc per rev, depending on the operation direction of the vehicle.

As will be understood, the purpose of preferably having both the front and rear motors 30, 20, as two speed motors, is to compensate for weight shifts between the front and rear drive 60 and 50, as the machine is driven up slopes 13 in forward or reverse.

### Forward Travel

For operations where power performance at lower speed is desired, or forward travel up steep slopes, the front motor 30 is manually set at the lower displacement of 25 cc per rev and the displacement of the rear motor 20 is manually set at 75 cc per rev. This setting is named Turtle. This overcomes the significant shifting of the vehicle's weight distribution while operating on a slope in forward travel.

For higher speeds with less power, the motors 20, 30 displacements are both manually set at 25 cc per rev. This setting is named Rabbit.

### Reverse Travel

When there is a need for the vehicle to climb a slope in reverse, the invention allows the operator to select maximum displacement for the drum drive motor 30 at 75 cc per rev and the axle motor 20 to its minimum displacement of 25 cc per rev. This places maximum torque at the point of maximum friction and minimum torque at the point of minimum friction. This overcomes the significant shifting of the vehicle's weight distribution while operating on a slope in reverse travel.

The displacement shifts described are accomplished, with the two speed hydraulic motors 20, 30, with solenoid valve controls (not shown) that are manually operated for simple effective operation, and works very well for 8 ton and also 10 ton soil rollers. The solenoid valve sends controlled pressure to either the maximum or minimum displacement control piston (not shown) in each motor. In this embodiment, it takes 12 volts to engage minimum displacement, and the lack of 12 volts selects maximum displacement.

The solenoid valve controls can be manually operated by a dash mounted switch (not shown). The switch can be in the form of a switch/valve, which depending on preferred action as described, controls the sending of the 12 volts to the motors 20, 30 in order to switch between Turtle, Rabbit and reverse slope operation.

If the vehicle, for instance a road roller, moves forward, the operator can manually set the displacement of the front and rear motors 30, 20, respectively, to the suitable control settings, namely, the Turtle setting or Rabbit setting. In the embodiment shown in FIG. 5, the front motor 30 is assigned to the front drum of the road roller. Depending on the desired driving speed, the motors 20, 30 are manually set at 25 cc per rev, for higher speeds with less power, or, the front motor 30 is set at the lower displacement of 25 cc per rev and the rear motor 20 is set at the higher displacement, 75 cc per rev, when a lower speed is desired or forward travel of steep slopes.

Because of this unequal distribution of the torques to the front drive 60 and rear drive 50 of the driven vehicle, during uphill motion, the drive which is relieved of load by the inclination of the plane is driven with less moment. For example, if a vehicle is moving up a hill, the leading drive tends to slip first. This tendency for slip to occur is counteracted by the reduction of the displacement on the front drive. The described distribution of the torques to the front and rear drive is carried out preventively irrespective of an actually occurring uphill motion, so that even in the case of a forward motion on level ground, the torque on the front drive can be reduced compared with the torque on the rear drive. The danger of errors in recognizing the driving situation is reduced by simply using the direction of motion as the basis.

In a change of direction of motion, the operator places the vehicle into the direction for backward motion (reverse). Corresponding to the change in direction of motion, the operator can set the displacements of the front and rear motors 30, 20 into the reverse slope operation setting. In the reverse slope operation setting, the rear motor 30 is consequently set to the lower displacement, and the front motor 20 is set to the higher displacement.

In practice, three (3) alternatives are useful: (1) the front drive motor 30 is set at 25 cubic centimeters per revolution, and the rear drive motor 20 is set at 75 cubic centimeters per revolution which works well for level ground and slope work in forward travel; (2) the front drive motor 30 and also the rear drive motor 20 are each set at 25 cubic centimeters per revolution for a higher travel speed on level ground in forward and reverse; (3) the front drive motor 30 is set at 75 cubic centimeters per revolution and the rear drive motor 20 is set at 25 cubic centimeters per revolution which works well for both level ground operation and, most importantly, for reverse slope operation.

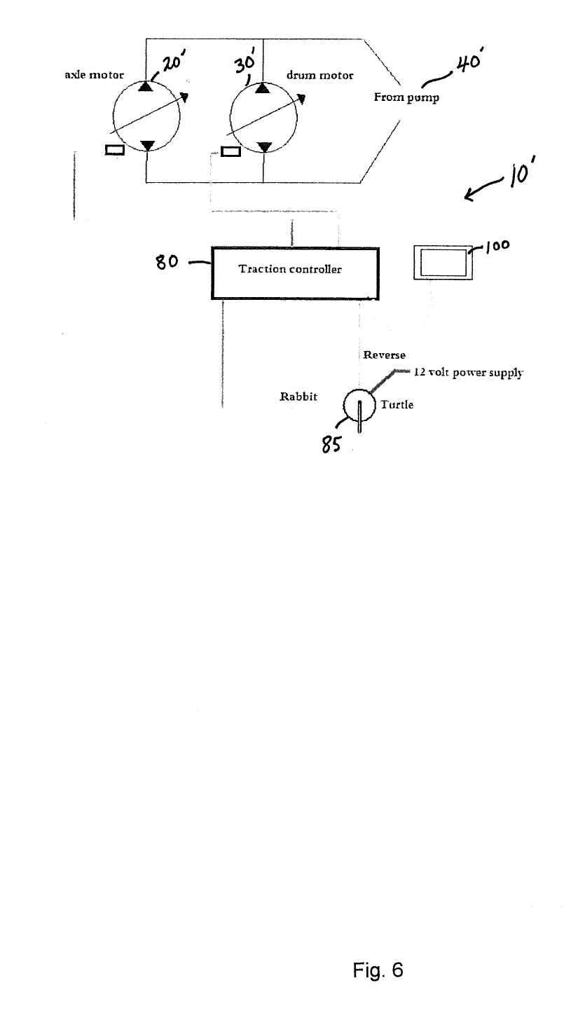

Referring to FIG. 6, a second embodiment of a hydraulic circuit 10′ is disclosed. The hydraulic circuit 10′ comprises a bi-directional hydraulic pump 40′ that is in hydraulic communication with a front hydraulic motor 30′ and a rear hydraulic motor 20′. The front hydraulic motor 30′ is in parallel hydraulic communication with the rear hydraulic motor 20′. The front motor 30′ drives a front drive (not shown), and, the rear motor 20′ drives a rear drive (not shown). The motors 20′, 30′ are preferable constructed identically in order to drive either wheels or drums or both.

The hydraulic motors, 20′, 30′ are variable displacement motors for, as will be described, suitable control settings. For example, for operations where a power performance at lower speed is desired, or forward travel up steep slopes, the front motor 30′ is set at a lower displacement, such as 25 cc per rev, and the displacement of the rear motor 20′ is set at a higher displacement, such as 75 cc per rev. This overcomes the significant shifting of the vehicle's weight distribution while operating on a slope in forward travel.

On the other hand, when there is a need for the vehicle to climb a slope in reverse, the front motor 30′ is set at a higher displacement, such as 75 cc per rev, and the rear motor 20′ is set at a lower displacement, for example, 25 cc per rev. This places torque at the point of maximum friction and minimum torque at the point of minimum friction. This overcomes the significant shifting of the vehicle's weight distribution while operating on a slope in reverse travel.

The displacement shifts described are accomplished, with the variable displacement motors 20′, 30′, and includes a microprocessor 100 based controller 80 that is electrically disposed between a switch 85 and the motors 20′, 30′. The controller 80 receives various sensing signals and controls the displacement of the motors 20′, 30′. In particular the sensing signals include signals representing the rotational speed of the front and rear drives. For example, a first speed sensor or drum speed sensor produces a first signal in response to the rotational speed of the front drive. Similarly, a second speed sensor or wheel speed sensor produces a wheel speed signal in response to the rotational speed of the rear drive. The controller 80 receives the speed signals, can compare the speed signal magnitudes to each other to determine which set of the ground engaging traction devices are slipping, and decrease the displacement of the motor associated with the slipping ground engaging traction device to increase the torque associated with the motor associated with the non-slipping ground engaging traction device. Preferably, the microprocessor based controller 80 receives 12 volt signals from the switch 85 and converts to a digital signal. The controller 80 then sends a signal in milivolts to the motor, which sets and holds selective displacements. The controller 80 interface allows easy and infinite adjustment to both motors.

The microprocessor 100 can utilize arithmetic units to control various processes according to software programs. Typically, the programs are stored in read-only memory, random-access memory or the like.

If the vehicle, for instance a road roller, moves forward the controller 80 can set the displacement of the front and rear motors 30′, 20′, respectively, to the suitable control settings, namely, the Turtle setting or Rabbit setting. In the embodiment shown in FIG. 6, the front motor 30′ is assigned to the front drum of the road roller. Depending on the desired driving speed, the motors 20′, 30′ are set for higher speeds with less power or, the front motor 30′ is set at the lower displacement of, for example 25 cc per rev, and the rear motor 20′ is set at the higher displacement of, for example, 75 cc per rev, when a lower speed is desired or forward travel of steep slopes.

In construction, efficiency is increased with the present invention by being able to drive up a relatively steep slope 13 in forward or reverse, as opposed to turning the machine around to drive up in forward.

Although the description above contains many specificities, these should not be construed as limiting the scope of the invention but as merely providing illustrations of some of the preferred embodiments of the present invention.

For example, the specific machines enumerated were 8 ton and 10 ton soil rollers. However, the circuit has much broader applications than those two (2) specific models of soil rollers. The present circuit will work on many types of machines that have two (2) drives connected in a parallel circuit, especially machines that have problems during slope operations caused by the shifting of the vehicle's weight.

It will be obvious to those skilled in the art that modifications may be made to the embodiments of the invention described above without departing from the scope of the present invention. Thus the scope of the invention should be determined by the appended claims in the formal application and their legal equivalence, rather than by the examples given.

I claim:

1. In a hydraulically driven vehicle, a hydraulic drive circuit comprising:
at least one bi-directional hydraulic pump in communication with a first hydraulic motor and a second hydraulic motor, wherein said first hydraulic motor drives a first drive, and
wherein said second hydraulic motor drives a second drive,
wherein each of said first and second hydraulic motors having a first displacement and a second displacement, and wherein said first displacement is lower than said second displacement,
wherein said first hydraulic motor is set at said first displacement and said second hydraulic motor is set at said second displacement in order to overcome the shifting of a vehicle's weight distribution while operating on a slope in forward travel, and wherein said first hydraulic motor is set at said second displacement and said second hydraulic motor is set at said first displacement in order to overcome the shifting of the vehicle's weight distribution while operating on the slope in reverse travel, and
displacement adjusting means for setting the displacement of said first and second hydraulic motors.

2. The hydraulic drive circuit as recited in claim 1, wherein said first and second hydraulic motors are two (2) speed hydraulic motors.

3. The hydraulic drive circuit as recited in claim 2, wherein each of said two (2) speed hydraulic motors are preset with said first and second displacements.

4. The hydraulic drive circuit as recited in claim 3, wherein said first displacement is set at 25 cc per rev and said second displacement is set at 75 cc per rev.

5. The hydraulic drive circuit as recited in claim 1, wherein said first hydraulic motor is in parallel hydraulic communication with said second hydraulic motor.

6. The hydraulic drive circuit as recited in claim 1, wherein said first drive is a drum.

7. The hydraulic drive circuit as recited in claim 1, wherein said second drive is an axle with wheels.

8. The hydraulic drive circuit as recited in claim 1, wherein said first and second hydraulic motors are variable displacement motors.

9. The hydraulic drive circuit as recited in claim 8, further including a controller that is electrically disposed between a switch and said first and second hydraulic motors.

10. The hydraulic drive circuit as recited in claim 9, wherein said controller receives sensing signals and controls the displacement of said first and second hydraulic motors.

11. The hydraulic drive circuit as recited in claim 10, wherein a first sensor produces a first signal in response to the rotational speed of said first drive, and a second sensor produces a second signal in response to the rotational speed of said second drive.

12. The hydraulic drive circuit as recited in claim 11, wherein said controller includes means responsive to said first and second signals applied to the displacement adjusting means.

13. A hydraulic drive circuit comprising:
separate drive means for applying torque to first and second drives of a vehicle,
a first hydraulic motor for powering the first drive means,
a second hydraulic motor for powering the second drive means, wherein each of said first and second hydraulic motors having a first displacement and a second displacement such that wherein said first displacement is lower than said second displacement,
a bi-directional hydraulic pump in communication with said first and second hydraulic motors,
a controller that is electrically disposed between a switch and said first and second hydraulic motors,
wherein said controller receives first and second sensing signals to control the displacement of said first and second hydraulic motors,
wherein a first sensor produces said first sensing signal in response to the rotational speed of said first drive, and a second sensor produces said second sensing signal in response to the rotational speed of said second drive.

14. The hydraulic drive circuit as recited in claim 13, wherein said first and second hydraulic motors are two (2) speed hydraulic motors.

15. The hydraulic drive circuit as recited in claim 14, wherein each of said two (2) speed hydraulic motors are preset with said first and second displacement.

16. The hydraulic drive circuit as recited in claim 15, wherein said first displacement is set at 25 cc per rev and said second displacement is set at 75 cc per rev.

17. Thy hydraulic drive circuit as recited in claim 13, wherein said first and second hydraulic motors are variable displacement motors.

18. The hydraulic drive circuit as recited in claim 13, wherein said first hydraulic motor is set at said first displacement and said second hydraulic motor is set at said second displacement while operating the vehicle on a slope in forward travel, and, wherein said first hydraulic motor is set at said second displacement and said second hydraulic motor is set at said first displacement while operating the vehicle on the slope in reverse travel.
